(19) United States
(12) Patent Application Publication
(10) Pub. No.: US 2005/0118553 A1
(43) Pub. Date: Jun. 2, 2005

(54) Mini-brush for interdental cleaning and care

(76) Inventor: Flavio Americo Lagos Galvan, Mexico City (MX)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/490,859

(22) PCT Filed: Sep. 26, 2002
(86) PCT No.: PCT/MX02/00092

(30) Foreign Application Priority Data
Sep. 28, 2001 (MX) PA/U/2001000277

(51) Int. Cl. A61C 3/00; A61C 15/00

(52) U.S. Cl. 433/141; 132/321; 132/323

(57) ABSTRACT

The invention relates to a mini-brush for interdental cleaning and care. Said mini-brush comprises a handle having an interdental brush disposed at one end thereof which is provided with bristles that gradually diminish in size. The smallest of said bristles are disposed at the most distal point of the device, while the other end thereof comprises a truncated pyramidal point which is used to massage the gums, said end taking the form of a triangle with a rounded tip. The inventive mini-brush is made from plastic materials and the pyramidal point thereof is made from a foam material that can hold gels or medicaments which are to be applied in the mouth of the user. The aforementioned pyramidal point can comprise an oval hole or groove for attaching dental floss.

### INVENTION'S PURPOSE

The present invention refers to a oral device with multiple functions for dental cleaning. The device is composed of an interdental brush on one of its ends. On the other end, of an interproximal point of a truncated and rounded triangular pyramidal section. The main part has a body or handle for a manual grip. The device may be molded from plastic materials; the use of a foamy polymeric material allows for the preimpregnation of the proximal point with different auxiliary substances such as fluoride gel, paste and medications, among others, for the care and improvement of gingival tissue, as well as dental hygiene.

### INVENTION'S BACKGROUND

The present invention is related to devices for intraoral cleaning, in particular, to personal devices for daily dental hygiene (Katz et al, 2000). Conventional toothbrushes, gels and toothpastes and dental floss and toothpicks are some elements of reference for personal dental hygiene. The toothbrush is a difficult device to maneuver and its structure makes its access to intricate parts and contours difficult and of difficult access to dentures (Brand et al, 1990). Due to these problems, dental floss is an aide for dental hygiene (Woodall et al, 1989). However, its maneuvering is complicated.

Electric versions of toothbrushes make their general use difficult due to their weight, size and cost.

Among the devices for interdental cleaning are interdental brushes whose use is recommended when the individual has spaces between teeth or large interproximal spaces. These devices consist of a handle on whose ends conical or cylindrical brushes are placed that work with natural, synthetic bristles or other materials, making the mechanical expulsion of leftover food particles possible (Woodall et al, 1989).

Users familiarize themselves with interdental brushing after a periodontal disease. Due to the different discomforts caused by said diseases, patients become reluctant to use this type of brush. With the purpose of improving this situation, the auxiliary use of devices not possessing bristles and which allow for the stimulation of gingival tissue by way of a massage of the same, helping to keep it healthy, is presented as an alternative (Youssef, 1986). The existence of a fixed prosthesis may also bring about special problems in oral hygiene requiring special care of the gingival tissue (Klinge et al, 1995).

One goal of the present invention is to provide an interdental minibrush conceived in order to allow the user to remove interproximal plaque in cases in which there is a space between the teeth, or when, due to poor alignment of said teeth, it is impossible to remove plaque with a conventional toothbrush or even with dental floss.

An additional goal of the present invention is to provide an interdental minibrush for removing interproximal tooth residue.

An additional goal of the present invention is to provide an interdental minibrush for dental cleaning even in extreme situations where proper conditions for performing such cleaning in a traditional manner do not exist. Due to its size and shape characteristics, the device may easily be transported, and its design facilitates dental hygiene and care, as well as its own preservation.

An additional goal of the present invention is to provide an interdental minibrush with the function of stimulating gingival tissue by way of a massage of the same in order to keep it healthy.

An additional goal of the present invention is to provide an interdental minibrush molded with plastic materials including a foamy material on one of its ends or on the entire brush. An additional goal of the present invention is to provide an interdental minibrush capable of retaining gels, medications and different auxiliary substances for application to the user's mouth during its use.

An additional goal of the present invention is to provide an interdental minibrush whose proximal end is adaptable to the position of the teeth and interproximal spaces, as well as to the manner in which the user presses the device.

Yet another additional goal of the present invention is to provide an interdental minibrush with an ergonomic body or handle for the Latino population in accordance with their physical characteristics.

Yet another additional goal of the present invention is to provide an interdental minibrush with a system of fastening dental floss that complements its functions.

Yet another additional goal of the present invention is to provide an interdental minibrush that performs the function of dental floss threading device in order to complement dental hygiene in cases of the use of prosthesis and orthodontic apparatus.

Yet another additional goal of the present invention is to provide an interdental minibrush that performs the function of support for dental floss (floss holder) that complements dental hygiene functions, allowing, in addition, dental floss to be saved, for the need of lesser length of the same and offering greater support on one of its ends.

The previous and other goals are reached, in accordance with the present invention, by way of an interdental minibrush consisting of two ends, on one of which the minibrush has an interdental brush and on the other, a proximal end or point of a truncated triangular pyramidal section with a rounded point supplied with a hook that makes its use as a dental floss threading device and floss holder possible in order to use it as an aide in hygiene procedures. In the main part, the minibrush has a body or handle. In an enunciative but unlimiting manner, the body's or handle's shape (in its cross-section) may be round, square, square with rounded, octagonal or hexagonal angles. In addition, I anticipated the existence of rounded points for the interdental brush in order to avoid injuries due to sharp ends.

The surface design of the lateral sufaces of the proximal or interproximal point favors gum massage. Upon exerting light pressure on this proximal point, which is transmitted to the gingival tissue, it mechanically stimulates said tissue and favors its upkeep or improvement.

An anatomical design is proposed, applying Mexican anthropometric measures (Esponda, 1994) that facilitate greater effectiveness in cleaning due to its use, as well as the best manual grip of the device.

In accordance with an additional characteristic of the invention, the minibrush is molded with a plastic (Menges et al, 1999) that may be a polyolefin (polyethylene or polypropylene), a nylon or a polyester.

In accordance with an additional characteristic of the invention, the proximal end of the minibrush may be molded with an open cell foam material that radially adheres around a rod of said proximal end.

In accordance with an additional characteristic of the invention, the foam material consists of polyurethane or polyolefins.

In accordance with yet another additional characteristic of the invention, the foamy proximal end may be shaped by way of a method that includes injecting a foam mixture into a mold in order to shape said end. The foam mixture may be a polyurethane prepolymer derived from toluene-diisocyanate, a mixture of polyoles and isocyanates, an elastomer or a foamable polyolefin. The rod of the proximal end must have a surface that unites with the foam formed.

In order to complement the previous description, and with the purpose of helping to give a better understanding of the invention's characteristics, attached to the present description, as an integral part of the same, are the drawings in which the following has been represented, in an illustrative and unlimiting nature:

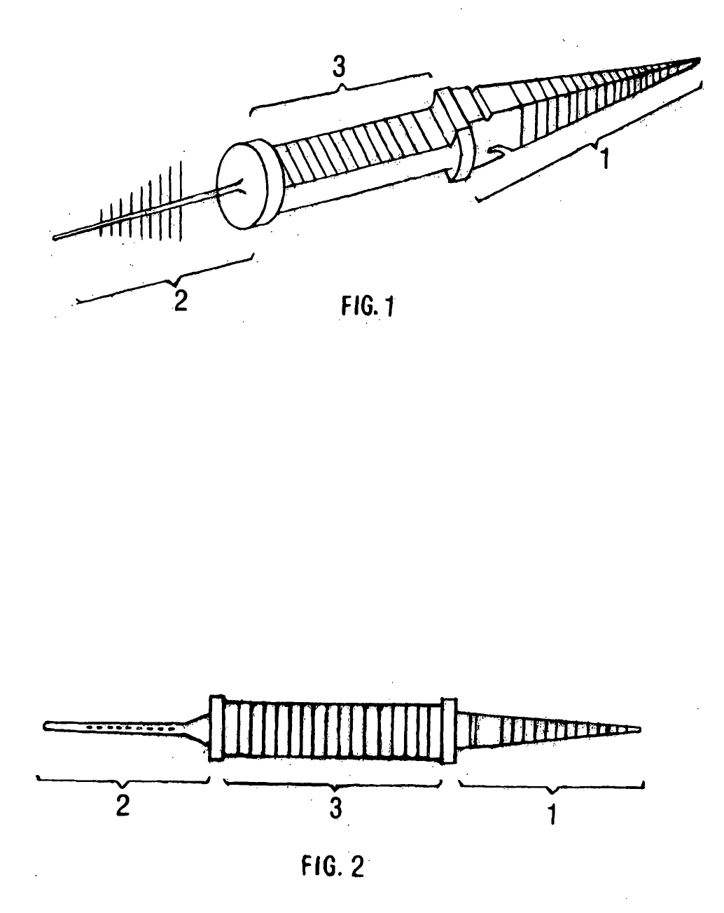

FIG. 1 shows a perspective view of the minibrush completed in accordance with the purpose of the present invention, showing the improved characteristics of the same.

FIG. 2 is a upper view of the minibrush showing the general characteristics of the same.

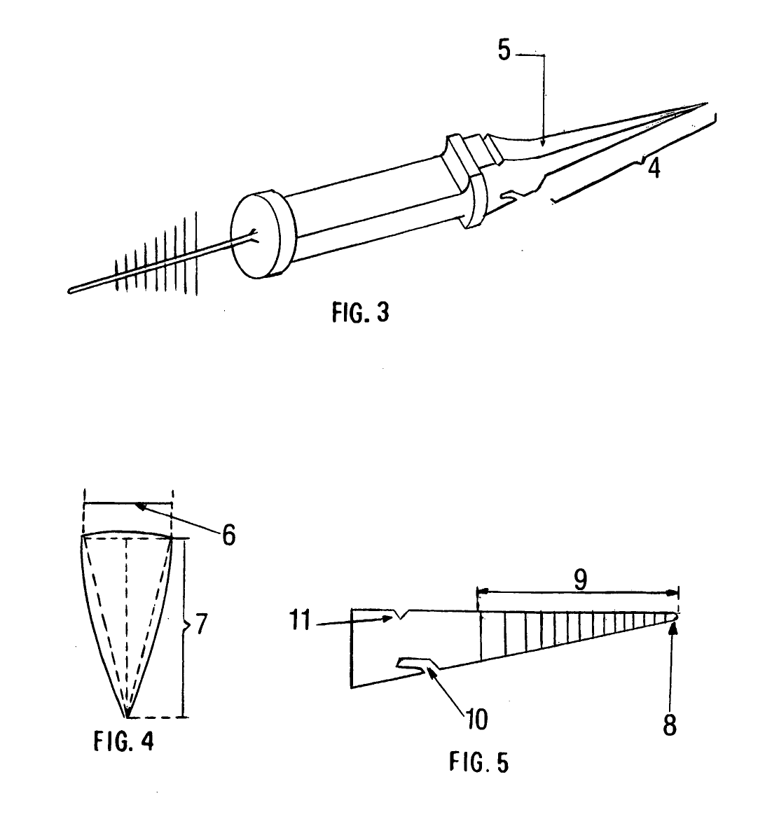

FIG. 3 is a perspective view of the rod for foaming the interproximal point.

FIG. 4 shows a profile view of the interproximal point.

FIG. 5 shows a side view of the interproximal point, where the details of said element are shown.

FIG. 6 is a side view of three versions of the surface finish of the lateral surfaces of the proximal end's point of the embodiment in FIG. 5.

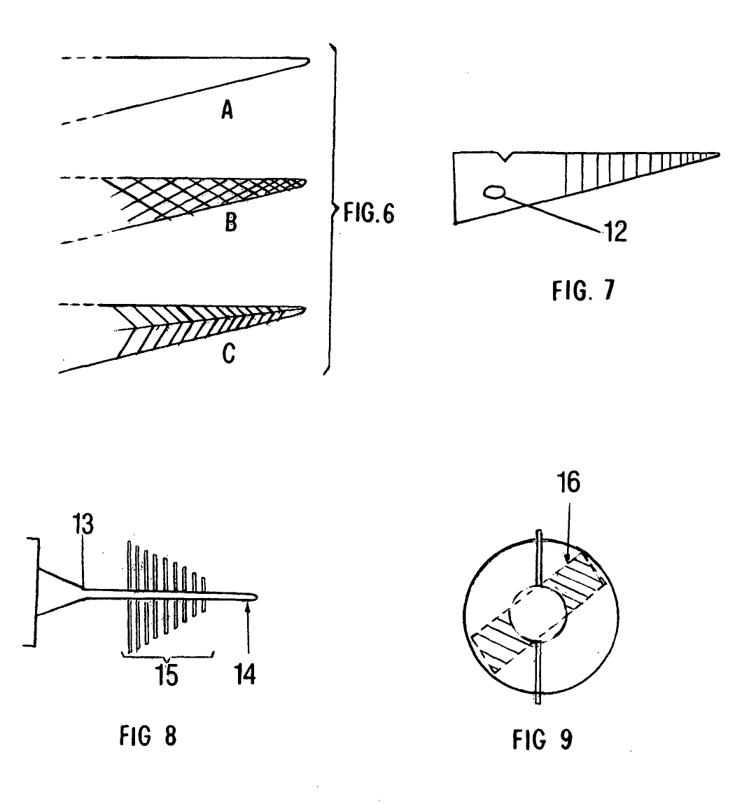

FIG. 7 is a side view of one version of the embodiment in FIG. 5.

FIG. 8 shows a side view of the interdental brush, where the details of the fibrillar structures are shown.

FIG. 9 shows a frontal view of one version of the embodiment in the shape of the profile of the minibrush's handle.

### REFERENCES

Berkowitz, Holland y Moxham. Atlas en color y texto de anatomía oral. Madrid: Mosby/Doyma Libros 2^{a} edicíon, 1995.
Brand, R. W., Isselhard, D. E. Anatomy of orofacial structures. Missouri: The C.V. Mosby Company, 1990.
Davis, W. L. Histología y Embriología Bucal. México: Ed. Interamericana-McGraw-Hill, 1^{a} edición, 1988.
Esponda, R. Anatomía Dental. Mexico: UNAM, 1994.
Katz, S.; McDonald; Stookey. Odontología Preventiva en acción. México: Ed. Médica Panamericana; 3^{a} Ed., 2000.
Klinge, B.; Ericson, D.; Matsson, L. La boca: dientes y tratamiento dental. Barcelona: Ediciones Doyma, 1995.
Menges, Michaeli. Moren: Spritzgliesswerkzeuge. Munich. Ed. Hanser, 1999.
Woodall, I.; Dafoe, B.; Young, N. Comprehensive Dental Hygiene Care. Missouri. The C.V. Mosby Co. 3^{e} Ed., 1989.
   Patents
U.S. Pat. No. 4,576,190 Youssef (1986)
U.S. Pat. No. 3,775,848 Barnett (1973)
U.S. Pat. No. 00D355,378 Dumont (1995)

### Invention's Preferential Realization

Preferred models of the invention will now be described, with reference to the attached drawings, in which the same reference numbers will be used in order to name the same elements or corresponding elements in the various views.

Regarding FIG. 1, the minibrush is shown with its component parts or sections: an interproximal or proximal point or end 1, an interdental brush 2 and a main part or handle 3. The interproximal point 1 of the minibrush allows for the removal of a greater volume of residue. The minibrush is molded using a conventional injection molding procedure. The preferred material for the minibrush is a polyolefin, either high-density polyethylene or polypropylene, although other materials may be used, supplied with an acceptable rigidity with good flexibility. Among the alternative materials are nylons or polyamides, polyesters and polyacetals. For the case of manufacturing the minibrush with the proximal end of a foamy material, the first phase of the process to obtain the rod 4 is begun as shown in FIG. 3 by injection molding, as previously mentioned. The surface of the part corresponding to the proximal point has a ribbed or bevelled finish 5 that allows for greater adherence to the material that will be foamy afterwards. If necessary, the rugosity of said surface may be increased by way of a mechanical abrasion procedure of the same. The foam proximal end or point is shaped from an open cell material that allows this end to have cavities in order to receive and retain different types of solids, fluids and pastes diffused toward the gingival tissue and the surface of the teeth, and the foam material will absorb water and will dry after use. The preferred material for the foam is polyethlene. Other possible foam materials include polyurethanes.

As can be seen in FIG. 4, the base of the proximal end has a triangular pyramide shape with a truncated point, starting from a scalene triangle with convex sides, as indicated in FIG. 4.

The scalene triangle mentioned has a dimensional ratio of 2:1 between the string that joins the ends of the base 6 of said side and the height of the perpendicular line to said base 7 together, as shown in FIG. 4. The proximal end or point has a total length of 20 mm and its point 8 is rounded, as seen in FIG. 5. Starting from the distal end of the point, there are 15 mm as active zone 9 of said end or element. The surface finish of the lateral surfaces of active zone 9 may be of a different type, as shown in FIG. 6, in order to facilitate or intensify the massage of gingival tissue by way of light pressure on this end. FIG. 6 a represents a finish formed by points aligned in a straight order parallel to the upper line of the proximal point and in straight vertical and parallel rows. The upper row of these elements is composed of bas-relief or cloven points, with regard to the plane of this point and the others, they are enhanced with reference to the plane mentioned. These last elements possess a rounded point. This type of design has an application for gingival stimulation in cases of high tissue sensitivity. Item b presents another type of finish for the proximal point, with a tissue structure in the shape of netting composed of rhombs of variable dimensions, starting from a lesser size in the distal point to a greater size on the mesial side. This structure carries out, on one hand, the function of serving the purpose of more easily expelling residue due to forward and backward movements, as well as more intensely stimulating the tissue upon exerting light pressure on the point and is recommended in cases of healthy tissue and for an intense massage of the tissue mentioned.

The structure in item c is formed by grooves in the shape of an arrowhead, formed starting from an axis on which the arrowheads mentioned are formed. This axis is made by a straight line originating from a height that represents 61% of the total of the straight side of the interproximal point and is parallel to the lower end of said point until it encounters the distal end. Each one of the arrowheads originates from the line made by a slope angle of 15° with regard to the straight side or the vertical line of the proximal point. This structure of the point favors the expulsion of leftover food particles in interdental spaces due to its shape and is recommended for standard stimulation gingival tissue.

On the mesial side of the interproximal point (the side closest to the minibrush's body) is a notch or hook 10 for the fastening of dental floss. Moreover, there is a groove on the upper surface 11 of the interproximal point. The combination of these elements makes its use as a threading device, support or floss holder possible, as needed.

FIG. 7 shows a version of the hook or notch of the proximal point, with an orifice in the shape of an oval 12 for the fastening of dental floss.

In FIG. 8, the structure of the interdental brush, formed by an axis 13 which ends in a rounded point 14 and a group of thin bristles 15, is seen. The presence of the axis 13 with a rounded point allows for its use as a toothpick. The existence of a set of bristles, small laminated structures or expeller fringe 15 on the distal end facilitates the cleaning of zones of difficult access. The bristles 15 are of different sizes and are ordered by size in an ascending manner starting from the distal end of the brush. The size of the bristles is given by a casing that determines their length and that has a conical shape with a 15° slope.

The main part of the minibrush 3 serves as a handle. The anatomical design of the body 3 is preferably made in the shape shown in FIG. 1 and the cylindrical profile is a preferable version. FIG. 9 shows an anatomical profile 16 with a 10° slope that makes a more secure and more comfortable manual grip possible.

Dimensions, without limitations, for a preferred model of the minibrush are, in millimeters:
Total length of the minibrush: 65
Length of the interproximal point or end: 20
Length of the active surface of the proximal point: 15
Distance from the distal end to the hook or notch: 17
Distance from the distal end to the groove for floss: 16
Length of the oval orifice: 2.0
Total length of the dental brush: 20
Diameter of the axis of the dental brush: 0.5
Minimum length of the brush bristles: 0.5
Maximum length of the brush bristles: 1.0
Length of the body or handle: 25

Dimensions of the rectangular profile of the body or handle for the preferred models
Long side (horizontal): 2.5
Short side (vertical): 1.5
Diameter of the body or handle for the cylindrical body version: 2.5

1. Minibrush for interdental cleaning and care of one piece composed of three sections, one main section composed of a handle, an end section composed of a triangular point with a rounded point (proximal or interproximal end), a third section at the opposite end of the handle that has a plurality of bristles.
Characterized in that the base of the triangular end there is a notch on the lower surface in the shape of a hook and a groove on the upper surface, which, in combination with the notch in the shape of a hook, allows dental floss to be latched on.

2. Minibrush for interdental cleaning and care according to claim 1, characterized in that, instead of the notch, it has an oval orifice on its proximal end.

3. Minibrush for interdental cleaning and care according to claim 1, characterized in that the surfaces of the triangular point may have different types of surface finishes in order to facilitate the expulsion of residue from interdental spaces and favor the most intense stimulation of gum tissue.

4. Minibrush for interdental cleaning and care according to claim 1, characterized in that the main section composed of the handle has a slope, preferably of 10°, in order to facilitate the manual grasp or grip of the minibrush.

5. Minibrush for interdental cleaning and care according to claim 1, characterized in that the length of the bristles increases from the distal end to the handle.
